(19) United States
(12) Patent Application Publication
(10) Pub. No.: US 2006/0086892 A1
(43) Pub. Date: Apr. 27, 2006

(54) Photosensitive lights for an electric vehicle

(76) Inventor: Yung Cheng Chen, Tao Yuan City (TW)

Correspondence Address: John S. Egbert;Harrison & Egbert, 7th Floor, 412 Main Street, Houston, TX, 77002, US

(21) Appl. No.: 11/035,443

(22) Filed: Jan. 14, 2005

(30) Foreign Application Priority Data
Oct. 26, 2004 (TW) 093216987

(51) Int. Cl. H01J 40/14

(52) U.S. Cl. 250/214 R

(57) ABSTRACT

A photosensitive light includes a photosensitive resistor set on the power supply circuit of the headlight, and on a predefined location (such as the control panel) of the electric vehicle. Through the installation of the photosensitive resistor, the on or off states of the headlight and the taillight can be automatically controlled with respect to the brightness of the surrounding environment. This can be applied to avoid the situations of forgetting to turn on or off the headlight due to the driver's negligence, and can enable the lights to be automatically turned on when the electric vehicle passes shaded and dark areas to ensure the driver's safety, and furthermore, achieves the progress of practicability of saving power, and prolonging the usage duration of the battery jar of the electric vehicle.

### RELATED U.S. APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### FIELD OF THE INVENTION

The present invention relates generally to an electric vehicle, more particularly to an electric vehicle with an innovative headlight and taillight, which can automatically turn on and off according to the surrounding brightness through a photosensitive resistor.

### BACKGROUND OF THE INVENTION

It has been noted that because electric vehicles have the advantages of lightweight, environmentally safe and easy usage, they now have become a kind of popular transportation tool for many people. However, more than half of the electric vehicle users are elders, patients and handicapped persons, and when they are driving electric vehicles through dark places (like tunnel, tree shadows, and overcast and rainy places), due to their slower reactions than those of normal people, they quite often cannot turn on the head and tail lights in time. Therefore, the safety of electric vehicle drivers is threatened, additionally due to their own poor eyesight, or others' bad visibility.

Another point to be cautioned about the use of the electric vehicles is the controlling and saving of electric power. Because electric vehicles fully rely on electric power to generate driving force and to supply the headlight, taillight and sidelight with power, if it is not controlled, managed and saved well, the power will certainly be used up in a fastened manner. This will shorten the overall duration of the usage. Besides the main power consumption for driving electric vehicles forward, the power usage of headlights and taillights also occupies an important aspect and becomes the reason of easy waste of electric power. The time for users to turn on headlights and taillights is mostly in the evening or on the overcast and rainy days, but after they turn on the lights, they will forget to turn off the lights and keep the lights on when they reactivate the vehicles, or when they get into a bright place. This quite obviously causes unwilling waste of power, and shortens the utilization duration of power. As a conclusion, the design of manually turning on or off the headlights and taillights adopted by existing electric vehicles has the severe problems of affecting driver safety if the driver forgets to turn on the lights, or wasting power if the drivers forget to turn off the lights.

As a result, aiming at the problems existing in nowadays usages of headlights and taillights of electric vehicles known from the above discussion, how to develop a type of new structure that is safer, more power-saving, and of more practicality, indeed becomes the aim and direction that must be further studied and breached by the concerning practitioners with further efforts.

In the light of this, the inventor, based on the experiences of designing and developing related products for many years, aimed at the above objective, and after detailed design and cautious evaluation, ultimately obtained an invention of real practicability.

### BRIEF SUMMARY OF THE INVENTION

The facts of improving functionality by the present invention follow.

The present invention provides an innovative structural design that the headlight and the taillight, based on the configuration of a photosensitive resistor, can be automatically turned on and off according to the surrounding brightness. As an innovative structure of electric vehicles, it is really the first seen design in this industry that meets the novelty requirement for new patents.

Through the improved special structural design, an electric vehicle is featured with automatic control of the on and off states of its headlight and taillight according to the brightness of it surrounding environment, which can truly avoid the situation of forgetting to turn off the headlight due to the driver's negligence and consequently achieves the progress of practicability in increasing safety, saving power, and really prolonging the usage duration of the battery jar of an electric vehicle.

The new effect and functionality achieved by the present invention follow.

Another control switch can be additionally set on the control panel of the head tube, and can force the lights to be turned on or off without the control of the photosensitive resistor. This meets the requirements as on some special occasions.

The above is the detailed description of the technical characteristics of this invention based on the instance that is implemented quite well. However, experts familiar with this technique are allowed to change and modify this invention as long as they do not depart from the spirit and principle of this invention. Any change and modification may still be confined to the following scope defined by the present patent.

### BRIEF DESCRIPTION OF THE SEVERAL VIEWS OF THE DRAWINGS

FIG. 1 shows a perspective view of the photosensitive resistance on the control panel of the electric vehicle.

FIG. 2 shows a top plan view of the control panel, and the diagram on the addition of an extra control panel.

FIG. 3 shows a graphic illustration of the circuit diagram of the photosensitive resistance.

### DETAILED DESCRIPTION OF THE INVENTION

The features and the advantages of the present invention will be more readily understood upon a thoughtful deliberation of the following detailed description of a preferred embodiment of the present invention with reference to the accompanying drawings.

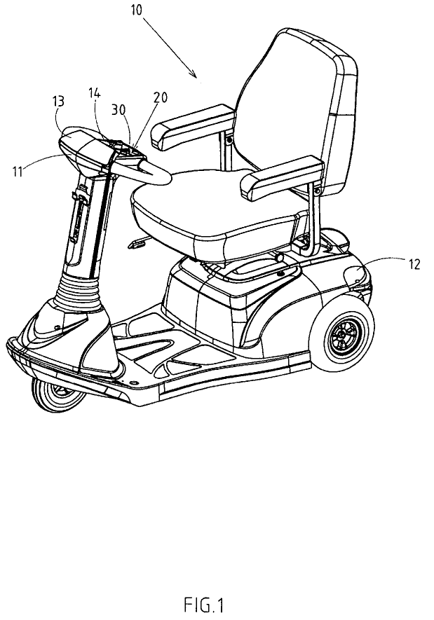

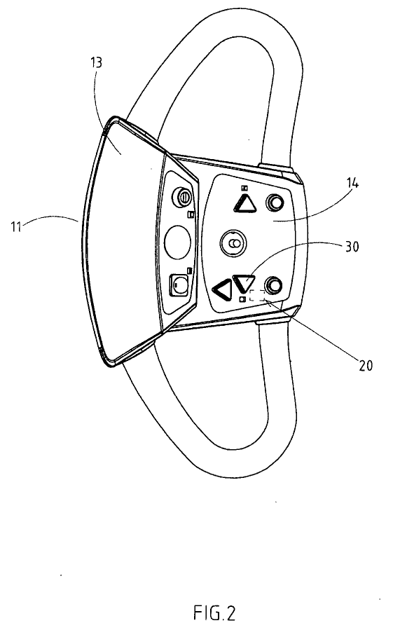

As shown in FIGS. 1-3, there is an electric vehicle embodied in the present invention.

The present invention has a photosensitive resistor 20, set on the power supply circuit of headlight 11 and taillight 12 and at a predefined site of the electric vehicle 10, which, according to surrounding brightness, enables the headlight 11 and taillight 12 to be automatically off or on, and then can achieve the effect of safe driving and power-saving.

Therein, the photosensitive resistor 20 is set on the control panel 14 of the head tube 13 on the electric vehicle 10.

Therein, another control switch 30 can be additionally set on the control panel 14 of the head tube 13, and can force the lights to be turned on or off without the control of the photosensitive resistor 20. This meets the requirements as on some special occasions.

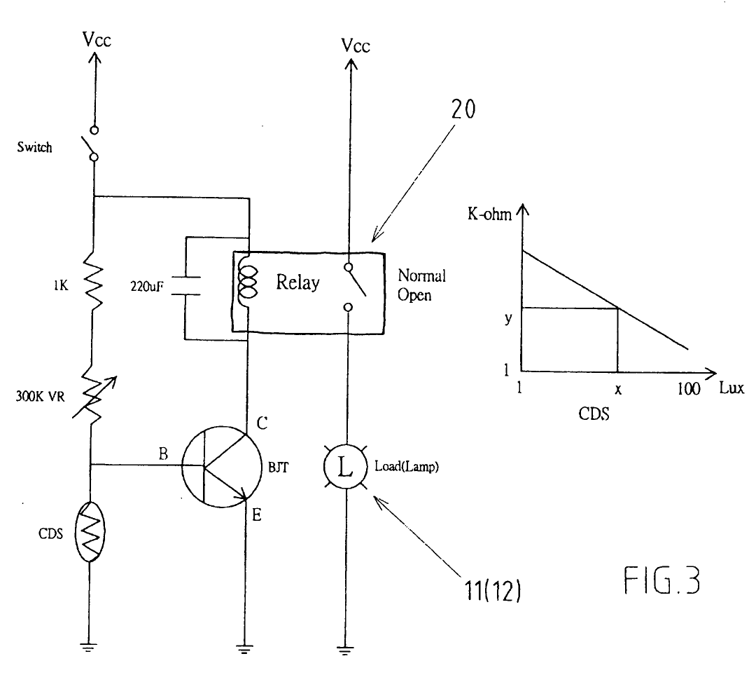

Therein, please refer to FIG. 3 for the operation principle of the photosensitive resistor 20 presented in this invention. When the Lux (the international unit for illumination), as shown in the figure, is larger than x, the resistance of CDS will be smaller than y and the voltage at B will be below 0.7V. In such situation, CE cannot be connected, and the relay (relay switch) has no action, keeping the normal open state. When the Lux is less than or equal to x, the resistance of the CDS will be larger than or equal to y and the voltage at B will be above 0.7V. Then the CE is connected, and then the capacity is connected to start charging. When it is full charged, the circuit is broken and the relay is connected, the Normal Open state will change to Close and then the circuit of the headlight and taillight will be switched on. (The capacity is then used to delay the turning on or off, that is, the time to turn on or off the headlight and the taillight will be delayed.)

I claim:

1. A photosensitive light for an electric vehicle comprising:
a photosensitive resistor, assembled and set at a predefined site of the electric vehicle, located on the power supply circuit of the headlight and the taillight, wherein, through the resistor, the on or off states of the headlight and the taillight can be automatically controlled with respect to the brightness of surrounding environment.

2. The photosensitive light defined in claim 1, wherein said photosensitive resistor can be assembled on the control panel lying on the head tube of the electric vehicle.

3. The photosensitive light defined in claim 2, wherein said additional control switch can be set on the control panel of the head tube, through such the vehicle can be free from the control of the photosensitive resistor, and can manually force the on or off of the headlight and the taillight.
